(19) United States
(12) Patent Application Publication
(10) Pub. No.: US 2003/0016237 A1
(43) Pub. Date: Jan. 23, 2003

(54) System for and method of emulating a database system

(76) Inventor: Neil Hickey, Golden, CO (US)

Correspondence Address: CHOATE, HALL & STEWART, EXCHANGE PLACE, 53 STATE STREET, BOSTON, MA, 02109-2891, US

(21) Appl. No.: 09/802,081

(22) Filed: Mar. 8, 2001

(51) Int. Cl. G06F 7/00

(52) U.S. Cl. 345/700

(57) ABSTRACT

A method of and system for providing one or more third-party program(s) the ability to access and cache the data of an existing software application that does not support standard database protocols. The invention employs a database shaping application for generating a rule set during a training sequence. The database shaping application monitors requests for data from third party programs and, according to the rule set, accesses the requested data from one or more existing host applications and translates the accessed data into a standard database protocol format, thereby emulating a database of the existing host application(s).

### FIELD OF THE INVENTION

The present invention relates generally to a system for and method of emulating a database system. More specifically, the invention monitors requests for data from third party programs and, according to a rule set established during a training sequence, accesses and extracts stored data via existing software applications which do not support standard database protocols. In this manner, the invention emulates the database of the existing software application(s). The invention also has potential application in the field of caching the data of an existing software application.

### BACKGROUND OF THE INVENTION

Standard protocols have been developed to allow access between newer software and data stored in relational database systems. Two examples are the ODBC and JDBC standards. Many third-party applications, third-party middleware products, and third-party Web content programs have been developed which support these protocols. However, much existing business data is stored in formats that are incompatible with these protocols. In addition, even if this data were made directly available to third-party applications through data migration, such a strategy would neglect the valuable business logic, such as error checking routines, associated with the existing software applications. This situation has created a niche for software companies that design software able to interface with existing software applications and to provide their associated data to third-party applications through strategies like database emulation and data caching.

Existing organizational software systems, including legacy systems, are in widespread use throughout the world. Because of the accelerating rates of technology development and changes in business methodologies, much of this software and its associated data have become inaccessible to current third-party software. Software products that make this data accessible to current applications could potentially extend the life of existing applications by decades. The market for such software products is measured in billions of dollars per year. Companies that can expand the usability, performance, and longevity of existing software systems could seize a significant portion of this market.

As existing software applications become outmoded, their associated data becomes difficult to access with recently standardized protocols. Often, the business logic inherent to these applications is still relevant, but the data is difficult for third-party tools to extract. A common strategy in the business world for overcoming this problem has been to rewrite entire applications so that data access is compatible with current standards. However, creating an entirely new application, especially a large and complex one, is often time-consuming and costly. Alternatively, a patchwork of software fixes intended to provide access to the data often requires a great deal of overhead and diminish the performance of even powerful systems. Diminished performance can lead to customer frustration, inefficient operation, and significant loss of business. What is needed is a way to extend the life of an existing application and its associated data.

Many existing applications, e.g. mainframe and legacy applications, provide no standardized means to access stored data other than through the screen interface. As a result, these applications and their associated data are of limited use to third-party tools that access stored data using standard database protocols like ODBC and JDBC. In order to present this stored data in current forms, such as is used on the Web and on wireless devices, often the only recourse is to port the data to a new platform. Unfortunately, data migration does not take advantage of the useful business logic inherent to the existing applications and does not provide real-time access to the data. What is needed is a way to provide a third-party software application with a means for real-time access to data associated with an existing software application that does not support standard database protocols.

Current methods for providing third-party tools the means to access data associated with existing software applications, such as migration and emulation, are resource-intensive, severely diminish the performance of the overall system. Diminished system performance can both negatively impact customer satisfaction with a business and slow operations within an organization, thus leading to inefficient operations and significant loss of business. Improved methods for accessing data can rectify this circumstance. What is needed is a way to dynamically update a database that supports standard database protocols with the data of an existing software application.

Much of the data extant in databases that do not support standard database protocols must be accessed frequently. For example, flight times stored in an airline scheduling application must be accessed thousands of times daily by both customers and airline personnel. Such frequent data access can inhibit system performance through repeated calls to the existing software, data translation, and data transmission to third-party tools. Placing frequently accessed data in a storage device accessible by standard database protocols would increase system performance. What is needed is a way to cache the data of an existing software application by on-demand updating of a database that supports standard database protocols.

### SUMMARY OF THE INVENTION

The present invention is a system for and method of emulating a database system. The system is able to monitor and reinterpret data streams present in existing software Systems that are not standard database protocol compliant and, according to a rule set established during a training sequence, provide this data to a separate database or to a third-party application using database protocols such as ODBC and JDBC. The contents of the applicant's U.S. Pat. Nos. 5,627,977 and 5,889,516, directed to a “trainable user interface translator” are herein incorporated by reference in their entirety.

In one aspect, the invention is a system for providing one or more third-party program(s) the ability to access data of an existing software application that does not support standard database protocols. The system is comprised of a database shaping computer operating a database shaping application, a training terminal for establishing a rule set during a training sequence, a shaper rule set storage device for storing the rule set, one or more client computers operating one or more third-party program(s) which use standard database protocols, and a host computer operating an existing host software application that does not support standard database protocols. The host computer may include a data storage device for storing resident data. The database shaping application, according to the rule set established during the training sequence, monitors requests for data transmitted from the one or more client computers via the one or more third-party program(s), and emulates a standard database by accessing the resident data stored on the data storage device via the existing host software application and translating the accessed resident data into a standard protocol format. The system may be configured with multiple host computers operating multiple host applications that are accessible to the database shaping application. One or more networks may preferably provide the interconnectivity among the various components of the system. The database shaping computer, host computer, and/or client computer(s) may all be the same device, or any two may be the same device. The system may optionally be configured with an auxiliary storage device that may be accessed by the database shaping application for combination with the resident data.

In another aspect, the invention is a method of training a system as described above to access an existing software application in order to emulate a database. The method comprises the steps of defining the requests and response data items as database tables and fields, accessing from the training terminal via the database shaping application the existing host application, exercising the existing host application from the training terminal via the database shaping application to create a sample database update, insert, or query request for one or more of the database tables and fields, and to generate a sample response, wherein the steps of exercising the existing host application are stored in the rule set, and determining if further training is required, and reverting to the defining step if further training is required.

In yet another aspect, the invention is a method of using a database emulation system to emulate a database, presupposing that a training session establishing a rule set has been completed. The method comprises the steps of starting the database emulation application, receiving at the database shaping computer a data request transmitted using a standard database protocol from the third party program, executing via the database shaping application the rule set stored in the rule shaper storage device, whereby the host application is accessed and exercised to return a response data packet, and transmitting a reply via the database shaping application to the third party program, thereby emulating a database. The response data packet transmitted to the third party program may be an exception if an error was generated in accessing the host application.

In another embodiment, the invention may provide on-demand caching of data of an existing software application that does not support standard database protocols by updating a database that may support standard database protocols. This is accomplished by configuring the system with a storage device for storing an update database that is searched first by the database shaping application, and if the requested data is not found there, the update database is updated with the requested data that the database shaping application extracts via the existing software application operating on the host computer. The invention can provide real-time access to data in an existing database while using an existing database application containing business logic, and additionally utilize the existing error checking and error handling functionality in the existing application. The invention can improve the performance and extend the useful life of an existing software application, and can be quickly implemented with a minimal amount of training for the user. The invention obviates the need to recode existing applications in order to gain increased functionality, and easily accommodates changes in the existing source application.

### BRIEF DESCRIPTION OF THE DRAWINGS

FIG. 1 is a block diagram of a system for providing a third-party software application with a means to access data of an existing software application that does not support standard database protocols.

FIG. 2 is a flow diagram illustrating a method of training a database emulation system to access an existing software application in order to emulate a database.

FIG. 3 is a flow diagram illustrating a method of using a database emulation system.

FIG. 4 is a block diagram of a system for on-demand caching the data of an existing software application by updating a database that may support standard database protocols.

FIG. 5 is a flow diagram illustrating a method of using a database emulation system to cache the data of an existing software application by on-demand updating of a database that supports standard database protocols.

### DETAILED DESCRIPTION

Preferred embodiments of the invention will now be described with reference to the accompanying drawings. A database shaping application and computer are referred to in the description below as a DB-Shaper application and DB-Shaper computer. These components assist in monitoring and reinterpreting data streams present in existing software systems that are not standard database protocol compliant and, according to a rule set established during a training sequence, provide this data to a separate database or to a third-party application using database protocols such as ODBC and JDBC.

I. First Embodiment: System for and Method of Emulating a Database

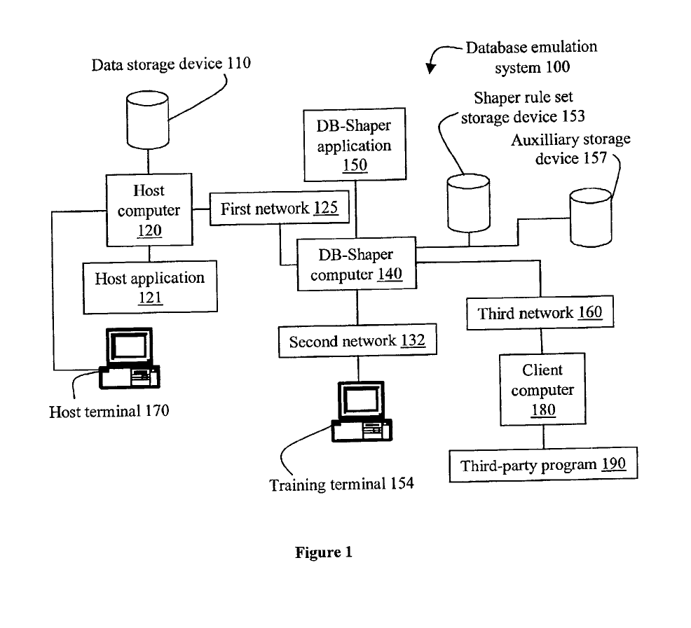

In one aspect, the invention is a system for and a method of emulating a database that supports standard database protocols. FIG. 1 is a schematic representation of a database emulation system 100. Database emulation system 100 includes a DB-Shaper computer 140, a host computer 120, a training terminal 154, and a client computer 180. Host computer 120 further includes a data storage device 110, a host application 121, and a host terminal 170. DB-Shaper computer 140 further includes a DB-Shaper application 150, auxiliary storage device 157, and a shaper rule set storage device 153. Client computer 180 further includes third-party program 190. DB-Shaper system also includes a first network 125, a second network 132, and a third network 160.

Host computer 120 may connect directly to DB-Shaper computer 140 or via first network 125, as shown in FIG. 1. Training terminal 154 and client computer 180 may connect directly to DB-Shaper computer 140 or via second network 132 and third network 160, respectively, as shown. First network 125, second network 132, and third network may be intranet networks or the Internet. Alternatively, two or all networks of first network 125, second network 132, and third network 160 may be the same network.

In an alternate configuration, multiple host computers 120 and/or multiple client computers 180 may connect to DB-Shaper computer 140. Similarly, host computer 120 may include multiple host applications 121. Also, host computer 120 and DB-shaper computer 150 may be the same device. Similarly, client computer 180 and DB-shaper computer 140 may be the same device, or alternatively all three may be the same device.

Training terminal 154 is typically a PC running terminal emulation software but may also be a directly connected display and keyboard. Host terminal 170 is typically a wired terminal like a 3270 or VT100-style terminal, but may also be other types. For the purposes of training the DB-Shaper system, training terminal 154 may also have the capability of emulating host terminal 170, thus obviating the need for host terminal 170 to be physically present.

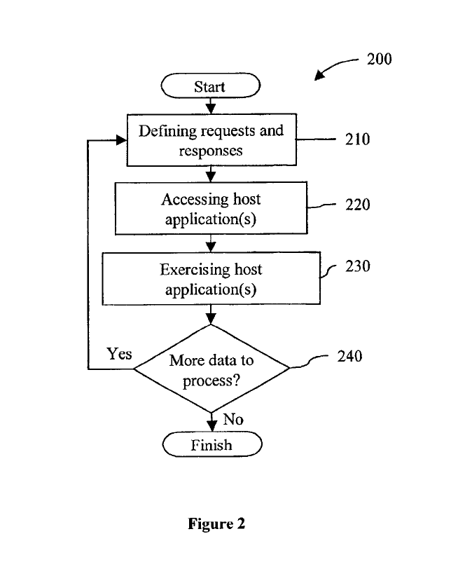

In operation, a request for data is transmitted from client computer 180 via third-party program 190 using standard database protocols such as ODBC and JDBC. Because data resident on data storage device 110 is inaccessible using standard database protocols, DB-Shaper application 150 accesses data storage device 110 via host application 121 and emulates a standard database by translating the stored data into a standard protocol format. DB-Shaper application 150 learns to perform this emulation during a training sequence depicted in FIG. 2 and described below. This embodiment provides third-party program 190 and client computer 180 with real-time access to data storage device 110. DB-Shaper application 150 may also combine data from data storage device 110 with data stored on auxiliary storage device 157.

A. Method of Training the Database Entulation System

A method of training database emulation system to access an existing software application in order to emulate a database is now described with reference to FIG. 2.

Step 210: Defining Requests and Responses

In this step, the trainer, using training terminal 154, defines the request and response data items to be supported. These items are defined as one or more database “tables” and their associated fields to be emulated. The definitions are stored on Shaper rule set storage device 153.

Step 220: Accessing Host Application(s)

In this step, the trainer, using training terminal 154, accesses host application 121 via DB-Shaper application 150.

Step 230: Exercising Host Application(s)

In this step, the trainer, using training terminal 154, creates a sample database update, insert, or query request for one or more of the emulated database tables. If an update or insert, the request will contain sample data to be entered into host application 121. If a query, the request will contain sample data to be passed to the host application 121 and a list of emulated fields in which to return data obtained from the host application. The trainer interacts with the host application 121 substituting the sample data as appropriate. Result data is stored into a sample response. This entire process is captured by the DB-Shaper application 150 and stored as a rule set on Shaper rule set storage device 153.

Step 240: More Data to Process?

In this step, the trainer determines if there are additional data requests to for which to perform training. If yes, process 200 returns to step 210; if no, process 200 ends.

B. Method of Emulating a Database Using Database Emulation System

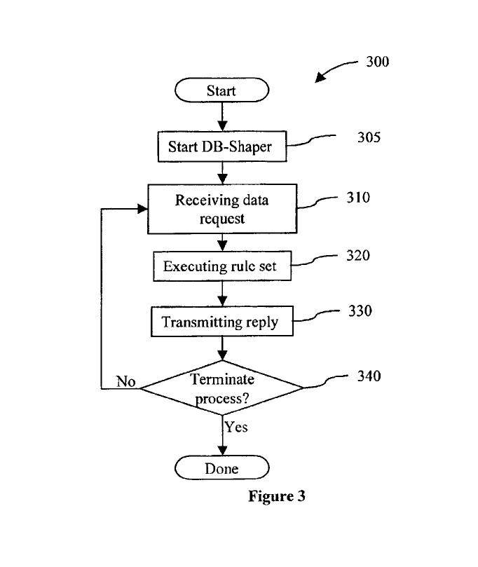

A method of using database emulation system 100 to emulate a database is now described with reference to FIG. 3.

Step 305: Starting DB-Shaper

In this step, the user starts the DB-Shaper application 150 using training terminal 154. Alternately, DB-Shaper application 150 may be set to start automatically when DB-Shaper computer 140 is turned on.

Step 310: Receiving Data Request

In this step, DB-Shaper application 150 waits for and receives a database request from third-party program 190. The request is transmitted using a standard database protocol such as ODBC or JDBC.

Step 320: Executing Rule Set

In this step, DB-Shaper application 150 executes the appropriate rule set, which is stored in shaper rule set storage device 153, based on the data request received in step 310. Based on the rule set, DB-Shaper application 150 returns a response data packet to third-party program 190. DB-Shaper application 150 may also return an exception to third-party program 190 if an error was generated in accessing the data.

Step 330: Transmitting Reply

In this step, DB-Shaper application 150 returns to step 310, ready to process the next request.

Step 340: Terminate Process?

In this step, DB-Shaper application 150 decides whether to terminate process 300. If yes, process 300 terminates; if no, process 300 returns to step 310.

II. Second Embodiment: A System for and a Method of On-Demand Caching the Data of an Existing Software Application by Updating a Database That May Support Standard Database Protocols

A. Cached Database Emulation System

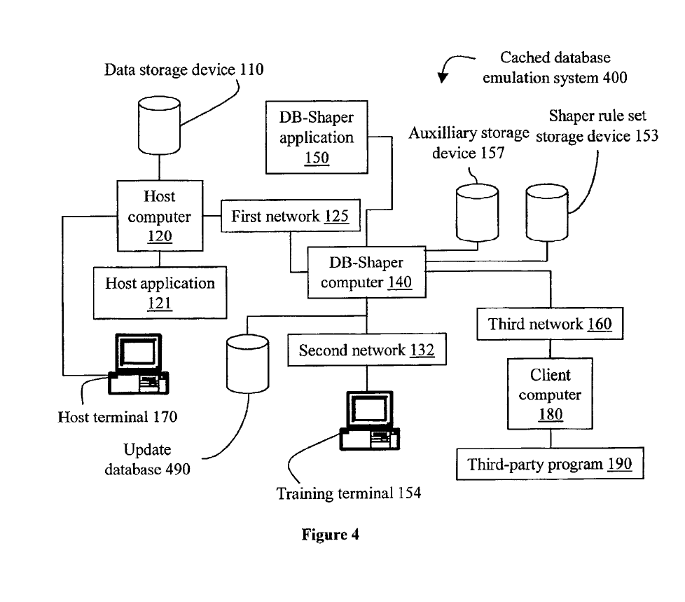

FIG. 4 is a schematic representation of a cached database emulation system 400. Cached database emulation system 400 is identical to database emulation system 100 but includes the addition of update database 490. Update database 490 is connected directly to DB-Shaper computer 140 and may be, but need not be, accessible by standard database protocols such as ODBC and JDBC.

The second embodiment is now described with reference to FIG. 4.

In operation, a request for data is transmitted from client computer 180 via third-party program 190 using standard database protocols such as ODBC and JDBC. This request is processed by DB-Shaper application 150. If the data is present in update database 490, DB-Shaper application 150 extracts the data from update database 490. If the requested data is not present in update database 490, DB-Shaper application 150 extracts the data from data storage device 110 via host application 121 and copies both the request and response data to update database 490. In both cases, the response data is returned to client computer 180. If update database 490 is ODBC or JDBC compliant, requests that are not supported by DB-shaper application 150 will be passed directly to the database DB-Shaper application 150 learns to perform the data extraction during a training sequence described in FIG. 2. In this manner, update database 490 serves as a data cache for data that would not normally be accessible to third-party program 190.

This embodiment is particularly useful for data that is accessed multiple times, such as flight times on an airline scheduling application. When a user requests a particular flight time that is not yet present on update database 490, DB-Shaper application 150 extracts it from data storage device 110. Every time thereafter that this flight time is requested, third-party program 190 extracts the data from update database 490, thereby increasing the speed of extraction and overall system performance.

B. Method of Using Cached Database Emulation System

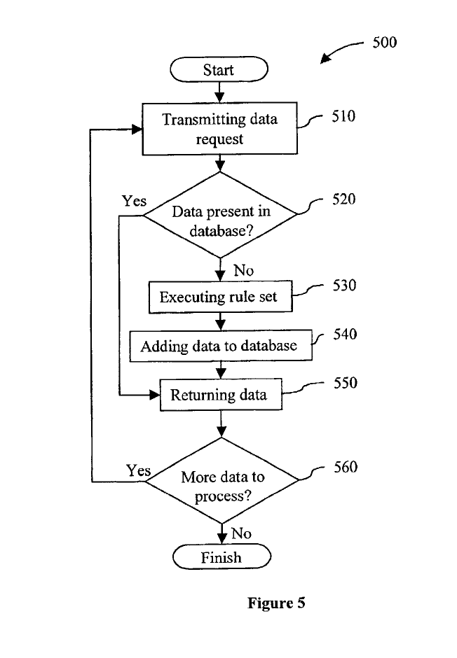

A method of using cached database emulation system 400 to cache the data of an existing software application by on-demand updating of a database that supports standard database protocols is now described with reference to FIG. 5.

Step 510: Transmitting Data Request

In this step, third-party program 190 transmits a request for data to DB-Shaper application 150 using a standard database protocol like ODBC or JDBC.

Step 520: Data Present in Database?

In this step, DB-Shaper application checks update database 490 for the presence of the data requested in step 510. If the requested data is present in update database 490, process 500 proceeds to step 550. If not, process 500 proceeds to step 530.

Step 530: Executing Rule Set

In this step, DB-Shaper application 150 executes the appropriate rule set based on the data request received in step 510.

Step 540: Adding Data to Database

In this step, DB-Shaper application 150 adds the requested data to update database 490.

Step 550: Returning Data

In this step, DB-Shaper application 150 returns a response data packet to third-party program 190. DB-Shaper application 150 may also return an exception to third-party program 190 if an error was generated in accessing the data.

Step 560: More Data to Process?

In this step, third-party program 190 determines if there are additional data requests to process. If yes, process 500 returns to step 510; if no, process 500 ends.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A system for providing one or more third-party program(s) the ability to access data of an existing software application that does not support standard database protocols, comprising:
a database shaping computer operating a database shaping application;
a training terminal communicatively connected to the database shaping computer for establishing a rule set during a training sequence;
a shaper rule set storage device for storing the rule set established during the training sequence communicatively connected to the database shaping computer;
one or more client computers operating one or more third-party program(s) which use standard database protocols, the one or more client computers communicatively connected to the database shaping computer;
a host computer operating an existing host software application that does not support standard database protocols, the host computer including a data storage device storing resident data and communicatively connected to the database shaping computer and a host terminal;
wherein the database shaping application, according to the rule set established during the training sequence, monitors requests for data transmitted from the one or more client computers via the one or more third-party program(s), and emulates a standard database by accessing the resident data stored on the data storage device via the existing host software application and translating the accessed resident data into a standard protocol format.

2. The system of claim 1, further comprising additional host computers operating one or more host applications that do not support standard database protocols communicatively connected to the database shaping computer accesses the resident data via the one or more host applications.

3. The system of claim 1, wherein one or more networks provide communicative connections between the database shaping computer and the host computer, the training terminal, and the one or more client computers.

4. The system of claim 1, wherein the host computer and the database shaping computer, or the database shaping computer and the one or more client computers are the same device.

5. The system of claim 1, wherein the host computer, the database shaping computer, and the one or more client computers are the same device.

6. The system of claim 1, further comprising an auxiliary storage device communicatively connected to the database shaping computer, the auxiliary storage device storing data that may be accessed by the database shaping application for combination with the resident data.

7. A method of training a database emulation system to access an existing software application in order to emulate a database, the database emulation system comprising a database shaping computer operating a database shaping application communicatively connected to a training terminal for establishing a rule set during a training sequence, a shaper rule set storage device for storing the rule set, and a host computer operating an existing host application, the method comprising the steps of:
defining from the training terminal the requests and response data items as database tables and fields;
accessing from the training terminal via the database shaping application the existing host application;
exercising the existing host application from the training terminal via the database shaping application to create a sample database update, insert, or query request for one or more of the database tables and fields, and to generate a sample response, wherein the steps of exercising the existing host application are stored in the rule set; and
determining if further training is required, and reverting to the defining step if further training is required.

8. The method claim 7, wherein the database emulation system further comprises multiple existing host applications which are accessed and exercised via the database shaping application.

9. A method of using a database emulation system to emulate a database, the database emulation system comprised of a database shaping computer operating a database shaping application and communicatively connected to a rule shaper storage device storing a rule set, a client computer operating a third party program using standard database protocols, and a host computer operating a host application, the method comprising the steps of:
starting the database emulation application;
receiving at the database shaping computer a data request transmitted using a standard database protocol from the third party program;
executing via the database shaping application the rule set stored in the rule shaper storage device, whereby the host application is accessed and exercised to return a response data packet; and
transmitting a reply via the database shaping application to the third party program, thereby emulating a database.

10. The method of claim 9, wherein the response data packet transmitted to the third party program is an exception if an error was generated in accessing the host application.

11. The method of claim 9, wherein in the database emulation system further comprises additional host computers operating one or more host applications that are accessed and exercised by the database shaping application.

12. A cached database emulation system for providing on-demand caching of data of an existing software application that does not support standard database protocols by updating a database that may support standard database protocols, comprising:
a database shaping computer operating a database shaping application;
an update database communicatively connected to the database shaping computer;
a training terminal communicatively connected to the database shaping computer for establishing a rule set during a training sequence;
a shaper rule set storage device for storing the rule set established during the training sequence communicatively connected to the database shaping computer;
one or more client computers operating one or more third-party program(s) which use standard database protocols, the one or more client computers communicatively connected to the database shaping computer;
a host computer operating an existing host software application that does not support standard database protocols, the host computer including a data storage device storing resident data and communicatively connected to the database shaping computer and a host terminal;
wherein the database shaping application, according to the rule set established during the training sequence, monitors requests for data transmitted from the one or more client computers via the one or more third-party program(s), and extracts requested data from the update database if present in the update database, or alternatively emulates a standard database by accessing the resident data stored on the data storage device via the existing host software application and translating the accessed resident data into response data in a standard protocol format and copies the request and the requested data to the update database.

13. A method of using a cached database emulation system to cache the data of an existing software application by on-demand updating of a database that supports standard database protocols, the cached database emulation system comprising a database shaping computer operating a database shaping application communicatively connected to an update database, a shaper rule set storage device storing a rule set, a third-party program which uses standard database protocols, and a host computer including a data storage device and operating an existing host software application that does not support standard database protocols, the method comprising the steps of:
transmitting from the third party program a request for data to the database shaping application;
determining by the database shaping application if the requested data is present in the update database, and if present proceeding immediately to the returning data step;
executing the rule set via the database shaping application to generate the requested data by accessing and exercising the existing host software application and data storage device;
adding the requested data to the update database;
returning the requested data to the third party program; and
determining if there are more requests for data to process.

14. The method of claim 9, wherein the response data packet transmitted to the third party program is an exception if an error was generated in accessing the existing host software application.
